(19) United States
(12) Patent Application Publication
(10) Pub. No.: US 2021/0165110 A1
(43) Pub. Date: Jun. 3, 2021

(54) EVENT DETECTION FOR VEHICLES

(71) Applicant: GM GLOBAL TECHNOLOGY OPERATIONS LLC, Detroit, MI (US)

(72) Inventors: Matt C. Neely, Rochester, MI (US); Eric T. Hosey, Royal Oak, MI (US); Russell A. Patenaude, Macomb Township, MI (US); Huong T. Chim, Madison Heights, MI (US)

(73) Assignee: GM GLOBAL TECHNOLOGY OPERATIONS LLC, Detroit, MI (US)

(21) Appl. No.: 16/701,578

(22) Filed: Dec. 3, 2019

(51) Int. Cl. G01S 19/47; G01S 19/40; H04W 4/02; H04W 4/40; H04W 4/90; B60W 40/10

(52) U.S. Cl. CPC G01S 19/47; G01S 19/40; H04W 4/027; B60W 2550/406; H04W 4/90; B60W 40/10; H04W 4/40

(57) ABSTRACT

In an exemplary embodiment, a vehicle is provided that includes an event detection system, one or more sensors, a processor, and a transceiver. The one or more sensors are configured to generate sensor data. The processor is configured to at least facilitate: receiving a first indication of a possible event having occurred for a vehicle, based at least in part on a loss of communications with the event detection system; upon receiving the first indication, determining whether the vehicle is moving, based at least in part on the sensor data; and providing instructions for transmitting an emergency call from the vehicle to a remote server, when both of the following conditions are satisfied, namely: the first indication has been received; and the vehicle is not moving. The transceiver is coupled to the processor, and is configured for transmitting the emergency call in accordance with the instructions from the processor.

### BACKGROUND

The technical field generally relates to vehicles, and more particularly relates to event detection for vehicles.

Many vehicles today include telematics units that provide detection of and responsive actions for vehicle events, such as when a vehicle contacts another vehicle or object. However, such event detection may be difficult in certain scenarios, for example when communication is unavailable with an event module or system of the vehicle and/or global navigation satellite system (GNSS) data is unavailable.

Accordingly, it may be desirable to provide improved methods and systems for detecting events in vehicles, for example when global navigation satellite system (GNSS) data is unavailable and/or communication is unavailable with an event module.

### SUMMARY

In an exemplary embodiment, a method is provided that includes: receiving a first indication of a possible event having occurred for a vehicle; upon receiving the first indication, determining, via a processor, whether the vehicle is moving; and transmitting an emergency call from the vehicle to a remote server, via instructions provided by the processor, when both of the following conditions are satisfied, namely: the first indication has been received; and the vehicle is not moving.

Also in an embodiment, the step of receiving the first indication includes receiving an indication of a loss of communications with a system of the vehicle.

Also in an embodiment, the step of receiving the first indication includes receiving an indication of a loss of communications with an event detection system of the vehicle.

Also in an embodiment, the step of receiving the first indication further includes receiving an additional indication of a loss of communications with a global navigation satellite systems (GNSS) for the vehicle.

Also in an embodiment, the step of determining whether the vehicle is moving includes determining, via the processor, whether the vehicle is moving based on sensor data obtained from one or more wheel sensors for the vehicle.

Also in an embodiment, the step of determining whether the vehicle is moving includes determining, via the processor, whether the vehicle is moving based on sensor data obtained from one or more speedometers for the vehicle.

Also in an embodiment, the step of determining whether the vehicle is moving includes determining, via the processor, whether the vehicle is moving based on sensor data obtained from one or more accelerometers for the vehicle.

Also in an embodiment, the step of determining whether the vehicle is moving includes determining, via the processor, whether the vehicle is moving based on a signal obtained from an external global navigation satellite system (GNSS) device.

In another exemplary embodiment, a system for a vehicle is provided, the system including a processor and a transceiver. The processor is configured to at least facilitate: receiving a first indication of a possible event having occurred for a vehicle; upon receiving the first indication, determining whether the vehicle is moving; and providing instructions for transmitting an emergency call from the vehicle to a remote server, when both of the following conditions are satisfied, namely: the first indication has been received; and the vehicle is not moving. The transceiver is coupled to the processor, and is configured for transmitting the emergency call in accordance with the instructions from the processor.

Also in an embodiment, the first indication includes an indication of a loss of communications with a system of the vehicle.

Also in an embodiment, the first indication includes an indication of a loss of communications with an event detection system of the vehicle.

Also in an embodiment, the first indication further includes an additional indication of a loss of communications with a global navigation satellite systems (GNSS) for the vehicle.

Also in an embodiment, the processor is configured to at least facilitate determining whether the vehicle is moving based on sensor data obtained from one or more wheel sensors for the vehicle.

Also in an embodiment, the processor is configured to at least facilitate determining whether the vehicle is moving based on sensor data obtained from one or more speedometers or accelerometers for the vehicle.

Also in an embodiment, the processor is configured to at least facilitate determining whether the vehicle is moving based on a signal obtained from an external global navigation satellite system (GNSS) device.

In another exemplary embodiment, a vehicle is provided that includes an event detection system, one or more sensors, a processor, and a transceiver. The one or more sensors are configured to generate sensor data. The processor is configured to at least facilitate: receiving a first indication of a possible event having occurred for a vehicle, based at least in part on a loss of communications with the event detection system; upon receiving the first indication, determining whether the vehicle is moving, based at least in part on the sensor data; and providing instructions for transmitting an emergency call from the vehicle to a remote server, when both of the following conditions are satisfied, namely: the first indication has been received; and the vehicle is not moving. The transceiver is coupled to the processor, and is configured for transmitting the emergency call in accordance with the instructions from the processor.

Also in an embodiment, the first indication further includes an additional indication of a loss of communications with a global navigation satellite systems (GNSS) for the vehicle.

Also in an embodiment, the vehicle sensors include one or more wheel sensors configured to generate wheel sensor data; and the processor is configured to at least facilitate determining whether the vehicle is moving based on the wheel sensor data.

Also in an embodiment, the vehicle sensors include one or more receivers configured to receive a signal from an external global navigation satellite system (GNSS) device; and the processor is configured to at least facilitate determining whether the vehicle is moving based on the signal.

Also in an embodiment, the vehicle sensors include one or more accelerometers configured to generate accelerometer data for the vehicle; and the processor is configured to at least facilitate determining whether the vehicle is moving based on the accelerometer data.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a communications system that includes a vehicle having a telematics unit, and that is configured to provide detection of and response for a vehicle event, in accordance with exemplary embodiments;

FIG. 2 is a flowchart of a process for providing detection of and response for a vehicle event, and that can be implemented in connection with the communications system and vehicle of FIG. 1, in accordance with exemplary embodiments; and

FIG. 3 is a functional block diagram of an exemplary control system of the vehicle of the communications system of FIG. 1 for implementing the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

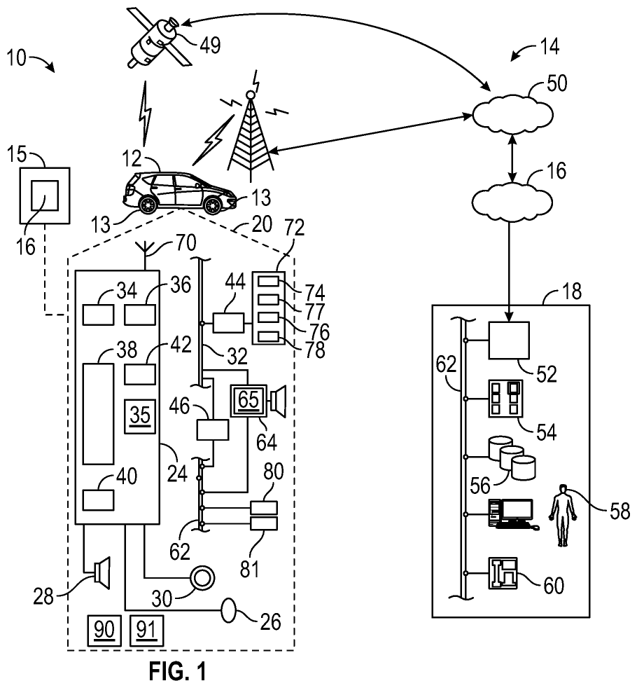

FIG. 1 is a functional block diagram of a communications system 10, in accordance with an exemplary embodiment. As described in greater detail further below, the communications system 10 generally includes a vehicle 12, along with one or more wireless carrier systems 14, one or more land networks 16, and one or more remote servers 18. As described in greater detail further below, in various embodiments, the communications system 10 provides for detection of vehicle events, and the providing of emergency calls accordingly, when a vehicle event is determined to be likely, based on a first indication of a potential vehicle event (e.g., including loss of communication with one or more vehicle systems) in combination with a determination that the vehicle is stationary (i.e., not moving).

It should be appreciated that the overall architecture, setup and operation, as well as the individual components of the illustrated system are merely exemplary and that differently configured communications systems may also be utilized to implement the examples of the method disclosed herein. Thus, the following paragraphs, which provide a brief overview of the illustrated communications system 10, are not intended to be limiting.

In various embodiments, the vehicle 12 may be any type of mobile vehicle such as a motorcycle, car, truck, recreational vehicle (RV), boat, plane, farm equipment, or the like, and is equipped with suitable hardware and software that enables it to communicate over communications system 10. As shown in FIG. 1, in various embodiments the vehicle hardware 20 is disposed within a body 19 of the vehicle 12, and includes a telematics unit 24, a microphone 26, a speaker 28, and buttons and/or controls 30 connected to the telematics unit 24. Operatively coupled to the telematics unit 24 is a network connection or vehicle bus 32. In various embodiments, the vehicle 12 has an engine (or motor) 90 that is started by an ignition system 91 (or other starting system), and that powers one or more wheels 13 of the vehicle 12. Examples of suitable network connections include a controller area network (CAN), a media-oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device, embedded within the vehicle 12, that provides a variety of services through its communication with the remote server 18, and generally includes an electronic processing device (processor) 38, one or more types of electronic memory 40, a cellular chipset/component 34, a transceiver 35, a wireless modem 36, a dual mode antenna 70, and a navigation unit containing a GPS chipset/component 42. In one example, the wireless modem 36 includes a computer program and/or set of software routines adapted to be executed within electronic processing device 38. Also in various embodiments, the transceiver 35 is configured to transmit, to one or more remote destinations (e.g., the remote server 18 of FIG. 1), data pertaining to the vehicle 12, including an emergency call for assistance when a vehicle event has occurred.

In various embodiments, the telematics unit 24 is embedded and installed (and built-in) within the vehicle 12 at the time of manufacture. In various embodiments, the telematics unit 24 enables voice and/or data communications over one or more wireless networks (e.g., wireless carrier system 14), and/or via wireless networking, thereby allowing communications with the remote server 18 and/or other vehicles and/or systems.

In various embodiments, the telematics unit 24 may use radio transmissions to establish a voice and/or data channel with the wireless carrier system 14 so that both voice and data transmissions can be sent and received over the voice and/or data channels. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), and the like. In one embodiment, dual mode antenna 70 services the GPS chipset/component 42 and the cellular chipset/component 34. In various embodiments, the telematics unit 24 utilizes cellular communication according to industry standards, such as LTE, 5G, or the like. In addition, in various embodiments, the telematics unit 24 carries out wireless networking between the vehicle 12 and one or more other network devices, for example using one or more wireless protocols such as one or more IEEE 802.11 protocols, WiMAX, or Bluetooth.

The telematics unit 24 may offer a number of different services for users of the vehicle 12, including providing data pertaining to the vehicle 12, and operation, tracking, and control thereof (and of various components thereof). In various embodiments, the telematics unit 24 communicates with a user via an electronic device 15 (e.g., a smart phone). In certain embodiments, the electronic device 15 includes one or more built-in sensors, such as an accelerometer 16. In addition, in various embodiments, the telematics unit 24 communicates with the remote server 18, for example in providing information regarding the vehicle 12, including making emergency calls for assistance in the case of a vehicle event.

In addition, in various embodiments, the telematics unit 24 also obtains vehicle-related information from various vehicle sensors 72, connected to various sensor interface modules 44 are operatively connected to the vehicle bus 32. In various embodiments, the vehicle sensors 72 include wheel sensors 74, accelerometers 76, speedometers 77, and gear selection sensors 78.

In certain embodiments, the wheel sensors 74 include one or more wheel position sensors and/or wheel speed sensors that detect and/or measure positions and movements of one or more wheels 13 of the vehicle 12, for use in determining whether the vehicle 12 is moving and for calculating a velocity for the vehicle 12 (for example, with respect to a path or roadway on which the vehicle 12 is travelling). Also in certain embodiments, the accelerometers 76 measure an acceleration for movement of the vehicle 12 with respect to a path or roadway on which the vehicle 12 is travelling. Also in certain embodiments, the speedometers 77 measure a speed of movement of the vehicle 12 with respect to a path or roadway on which the vehicle 12 is travelling. In addition, in certain embodiments, the gear selection sensors 78 detect a selected transmission gear from a transmission system 82 for the vehicle 12 for operation of the vehicle 12, such as park, reverse, neutral, and drive (PRND), and so on. In various embodiments, the sensor data for the vehicle 12 is provided by the various sensors 72 on the vehicle bus 32, and is received therefrom by the processor 38 described herein.

In various embodiments, the vehicle sensors 72 may also include any number of other sensors, such as by way of example, steering angle sensors, braking system sensors, gyroscopes, magnetometers, emission detection, and/or control sensors, and the like. Example sensor interface modules 44 include powertrain control, climate control, and body control, to name but a few.

Also in various embodiments, the telematics unit 24 is coupled to an event detection system 81 that detects and/or determines when a vehicle event has taken place. In certain embodiments, the event detection system 81 comprises an airbag system for the vehicle 12. As set forth in greater detail further below, in various embodiments, the telematics unit 24 makes emergency calls to the remote server 18 when it is determined that a vehicle event is likely to have occurred, based on information received (or failed to be received) from the event detection system 81, in combination with an additional determination as to whether the vehicle 12 is moving (e.g., with respect to a path or roadway on which the vehicle 12 has been traveling, as determined using sensor data from the vehicle sensors 72 and/or from the electronic device 15 described herein).

In addition, in various embodiments, the telematics unit 24 may also provide other services, such as, by way of example: turn-by-turn directions and other navigation-related services provided in conjunction with the GPS chipset/component 42, other emergency assistance services, information requests from the users of the vehicle 12 (e.g., regarding points of interest en route while the vehicle 12 is travelling), and/or infotainment-related services, for example in which music, internet web pages, movies, television programs, videogames, and/or other content are downloaded by an infotainment center 46 that may be part of the telematics unit 24 and/or operatively connected to the telematics unit 24 via vehicle bus 32 and audio bus 22, among various other types of possible services.

With respect to other electronic components utilized in connection with the telematics unit 24, the microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and remote server 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with remote server 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22. In various embodiments, the audio component 64 includes radio system 65 (which also includes antenna 70, as well as amplifiers, speakers, and the like, in certain embodiments).

The wireless carrier systems 14 may be any number of cellular telephone systems, satellite-based wireless systems, and/or any other suitable wireless systems, for example that transmits signals between the vehicle hardware 20 and land network 16 (and/or, in certain embodiments, that communicate directly with the vehicle 12 and/or the remote server 18). According to certain examples, wireless carrier system 14 may include and/or be coupled to one or more cell towers 48, satellites 49, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14.

The land network 16 can be a conventional land-based telecommunications network that is connected to one or more landline telephones, and that connects wireless carrier system 14 to remote server 18. For example, the land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

The remote server 18 is designed to provide the vehicle hardware 20 with a number of different system back-end functions and, according to the example shown here, generally includes one or more switches 52, servers 54 (e.g., including one or more processors), databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. Additionally, as noted above, the remote server 18 is configured to receive emergency calls from the vehicle 12 when a vehicle event is detected.

The transceivers 35, and/or modem or other telecommunication/computer equipment 60 may include an encoder, as previously explained, and can be connected to various devices such as a server 54 and database 56. In various embodiments, the database 56 of the remote server 18 comprises a computer memory that stores information, including regarding operation of the vehicle. Although the illustrated example has been described as it would be used in conjunction with a remote server 18 that is manned, it will be appreciated that the remote server 18 can be any central or remote facility, manned or unmanned, mobile or fixed, to or from which it is desirable to exchange voice and data. In various embodiments, the transceiver 35 facilitates communications between the telematics unit 24 and both the user's electronic device 15 and the remote server 18.

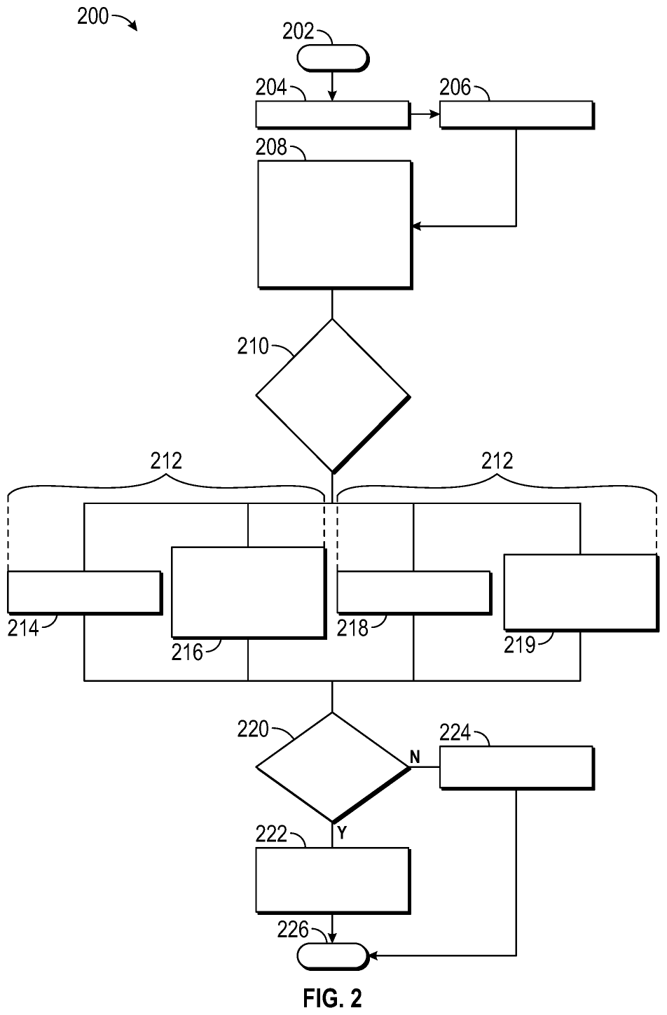

FIG. 2 is a flowchart of a process 200 for providing detection of and response for a vehicle event, in accordance with exemplary embodiments. In various embodiments, the process 200 can be implemented in connection with the communications system and vehicle of FIG. 1.

As depicted in FIG. 2, in various embodiments the process 200 begins at step 202. In certain embodiments, the process 200 begins when the vehicle 12 is turned on and/or begins travelling, and/or when one or more users of the vehicle 12 approach or enter the vehicle 12, when a user request has been received, and/or when use or operation of the vehicle 12 is expected. In certain other embodiments, the steps of the process 200 are performed continuously during operation of the vehicle 12.

In various embodiments, vehicle sensor data is obtained at 204. In various embodiments, the vehicle sensor data is obtained from the vehicle sensors 72 of FIG. 1. Specifically, in various embodiments, the vehicle sensor data is obtained via the wheel sensors 74, accelerometers 76, speedometers 77, and gear sensors 78 of FIG. 1, as to the position or movement of the wheels 13, acceleration of the vehicle 12 (e.g., with respect to a path or road on which the vehicle 12 has been travelling), velocity of the vehicle 12 (e.g., with respect to a path or road on which the vehicle 12 has been travelling), and a current or selected gear from the transmission system 80 of FIG. 1, respectively.

In addition, in certain embodiments, sensor data is also obtained from or regarding the electronic device 15, for example a signal strength from the electronic device 15 (e.g., as measured and/or obtained via the antenna 70) and/or sensor data from the electronic device 15 (e.g., from an accelerometer 16 of the electronic device 15 and/or pertaining to additional GPS data from the electronic device 15). In certain embodiments, the sensor data is obtained, directly or indirectly, via the processor 38 of FIG. 1.

Also in various embodiments, additional data is obtained at 206. In certain embodiments, the additional data is obtained via communications from various systems of the vehicle 12, specifically including the event detection system 81 of the vehicle and a global navigation satellite systems (GNSS) system of the vehicle (e.g., the GPS component or system 42 of FIG. 1). In various embodiments, the additional data comprises communications with the event detection system and GNSS system at regular intervals (e.g., receiving a “heartbeat” from such systems).

In various embodiments, a first indication is received as to a potential vehicle event at 208. In certain embodiments, the first indications comprises a loss of communications from one or both of the event detection system and the GNSS system (e.g., a failure to receive expected signals or “heartbeats” from one or both of these systems). In one exemplary embodiment, the first indication comprises a loss of communications from the event detection system (e.g., a failure to receive expected signals or “heartbeats” from the event detection system, such as via the antenna 70 and/or via the vehicle bus 32). In another exemplary embodiment, the first indication is satisfied when there is a loss of communications from both the event detection system and the GNSS system (e.g., a failure to receive expected signals or “heartbeats” from both of these systems, such as via the antenna 70 and/or via the vehicle bus 32). In certain embodiments, the processor 38 determines when the first indication of the potential vehicle event has been received.

Also in various embodiments, an evaluation is conducted at 210 as to additional inputs for verification of the potential vehicle event. In various embodiments, the processor 38 of FIG. 1 evaluates various sensor data 212 from the vehicle sensors 72 and from the electronic device 15 from step 204, including vehicle dead reckoning sensor data 214 and signal strength data 216 for the electronic device 15 of FIG. 1, and/or device GPS data 218 and/or device sensor data 219 from the electronic device 15 of FIG. 1 and/or from one or more other electronic devices and/or global navigation satellite systems (GNSS). For example, in certain embodiments, during step 210, the processor 38 of FIG. 1 conducts analysis regarding one or more of the following: (i) wheel position data and/or wheel speed data from the wheel sensors 74 (e.g., from the vehicle dead reckoning data 214); (ii) vehicle acceleration data from the vehicle accelerometers 76 (e.g., from the vehicle dead reckoning data 214); (iii) vehicle speed data from the speedometers 77 (e.g., from the vehicle dead reckoning data 214); (iv) vehicle transmission gear data from the transmission gear sensors 78 (e.g., from the vehicle dead reckoning data 214); (v) signal strength data of signals from the electronic device (e.g., as measured via the antenna 70 as part of the signal strength data 216); (vi) additional GPS data from the electronic device 15 (e.g., as received via the antenna 70 as part of the device GPS data 218) and/or from one or more other external global navigation satellite system (GNSS) devices, such as of a user onboard the vehicle (e.g., in certain embodiments, that is not part of the vehicle 12 itself but that may be presently onboard the vehicle 12); and (vii) accelerometer data from an accelerometer 16 of the electronic device (e.g., as received via the antenna 70 as part of the from the device sensor data 219).

In various embodiments, a determination is made at 220 as to whether the vehicle is stationary. In various embodiments, the processor 38 of FIG. 1 determines whether the vehicle is stationary (i.e., not moving) with respect to a path or road on which the vehicle 12 has been travelling, based on one or more of the various types of sensor data 212 described above in connection with the evaluation of step 210. Specifically, in various embodiments, the vehicle is determined to be stationary (i.e., not moving) if any of the following criteria are satisfied, namely: (i) the wheel position data and/or wheel speed data from the wheels sensor 74 show the wheels 13 to be not moving; (ii) the vehicle acceleration data from the vehicle accelerometers 76 shows the vehicle 12 to be not moving; (iii) the vehicle speed data from the speedometers 77 shows the vehicle 12 to be not moving; (iv) the vehicle transmission gear data from the transmission gear sensors 78 show the vehicle to be in “park”; (v) the signal strength data from the electronic device shows the vehicle 12 to be not moving (e.g., when the signal strength is not changing); (vi) additional GPS data from the electronic device 15 shows the electronic device 15, and therefore the vehicle 12, to be not moving; and/or (vii) the accelerometer data from an accelerometer 16 of the electronic device shows the electronic device 15, and therefore the vehicle 12, to be not moving.

If it is determined at step 220 that the vehicle is stationary (i.e., not moving, for example with respect to a path or road on which the vehicle has been travelling), then an emergency call is placed at 222. Specifically, in various embodiments, the processor 38 of FIG. 1 provides instructions for the transceiver 35 of FIG. 1 to place an emergency call with the remote server 18 of FIG. 1. In various embodiments, the emergency call provides an indication to the remote server 18 that a vehicle event is believed to have occurred (or has likely occurred) for the vehicle 12. In various embodiments, the remote server 18 then may provide further communications with emergency authorities (e.g., ambulance, fire department, police department, or the like), as well as with occupants of the vehicle 12 (e.g., to obtain and/or provide additional information and/or instructions, and so on). In certain embodiments, the process then terminates at 226.

Conversely, if it is instead determined at step 220 that the vehicle is not stationary (i.e., is moving), then an emergency call is not placed (step 224). Specifically, in various embodiments, the processor 38 of FIG. 1 provides instructions for the transceiver 35 of FIG. 1 to not place an emergency call with the remote server 18 of FIG. 1. In certain embodiments, the process then terminates at 226.

Accordingly, in accordance with various embodiments, methods and systems are provided for detecting vehicle events, and for making emergency calls to a remote server when it is believed that a vehicle event has occurred. Specifically, in various embodiments, a first indication is received regarding a potential event, when communications are lost with a vehicle detection system of the vehicle (and, in certain embodiments, provided further that communications with a GNSS system are also lost). In various embodiments, in such circumstances, various additional sensor data is evaluated to determine whether the vehicle is stationary (i.e., not moving, for example with respect to a path or road on which the vehicle is travelling). Once the first indication of a potential vehicle event has been received, a vehicle event is determined to have taken place, and an emergency call is placed with the remote server, if the vehicle is stationary (i.e., not moving). Conversely, if the vehicle is not stationary (i.e., is moving), then a vehicle event has been determined to not have taken place, and therefore no emergency call is made.

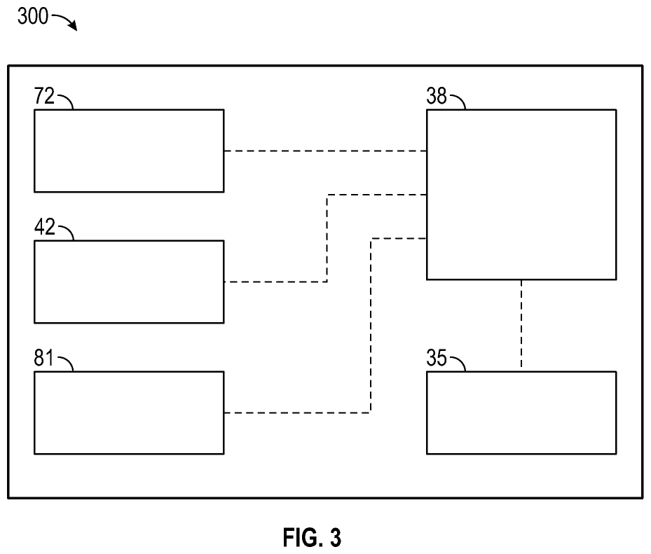

With respect to FIG. 3, a functional block diagram is provided of an exemplary control system 300 of the vehicle 12 of the communications system 10 of FIG. 1 for implementing the process 200 of FIG. 2, in accordance with exemplary embodiments. As depicted in FIG. 3, in an exemplary embodiment, the control system 300 includes sensors 71, a global navigation satellite systems (GNSS) (e.g., GPS) 42, an event detection system (e.g., airbag system) 81, a processor 38, and a transceiver 35, with features and functions as described above in connection with FIGS. 1 and 2. In certain embodiments, the process 200 may be implemented via the system 300 of FIG. 3 either alone or in combination with other apparatus, such as other components of the vehicle 12 and/or the communications system 10 of FIG. 1.

It will be appreciated that the systems and methods may vary from those depicted in the Figures and described herein. For example, the communications system of FIG. 1, including the vehicle, telematics unit, the electronic device, the remote server, the communications networks, and/or components thereof, may vary from that depicted in FIG. 1 and/or described herein, in various embodiments. It will similarly be appreciated that the process (and/or subprocesses) disclosed herein may differ from those described herein and/or depicted in FIG. 2, and/or that steps thereof may be performed simultaneously and/or in a different order as described herein and/or depicted in FIG. 2, among other possible variations. It will similarly be appreciated that the control system of FIG. 1, and/or components thereof, may also vary from that depicted in FIG. 3 and/or described herein, in various embodiments.

While at least one example has been presented in the foregoing detailed description, it should be appreciated that a vast number of variations exist. It should also be appreciated that the example or examples are only examples, and are not intended to limit the scope, applicability, or configuration of the disclosure in any way. Rather, the foregoing detailed description will provide those skilled in the art with a convenient road map for implementing the example or examples. It should be understood that various changes can be made in the function and arrangement of elements without departing from the scope of the appended claims and the legal equivalents thereof

What is claimed is:

1. A method comprising:
receiving a first indication of a possible event having occurred for a vehicle;
upon receiving the first indication, determining, via a processor, whether the vehicle is moving; and
transmitting an emergency call from the vehicle to a remote server, via instructions provided by the processor, when both of the following conditions are satisfied, namely:
the first indication has been received; and
the vehicle is not moving.

2. The method of claim 1, wherein the step of receiving the first indication comprises receiving an indication of a loss of communications with a system of the vehicle.

3. The method of claim 2, wherein the step of receiving the first indication comprises receiving an indication of a loss of communications with an event detection system of the vehicle.

4. The method of claim 3, wherein the step of receiving the first indication further comprises receiving an additional indication of a loss of communications with a global navigation satellite systems (GNSS) for the vehicle.

5. The method of claim 1, wherein the step of determining whether the vehicle is moving comprises determining, via the processor, whether the vehicle is moving based on sensor data obtained from one or more wheel sensors for the vehicle.

6. The method of claim 1, wherein the step of determining whether the vehicle is moving comprises determining, via the processor, whether the vehicle is moving based on sensor data obtained from one or more speedometers for the vehicle.

7. The method of claim 1, wherein the step of determining whether the vehicle is moving comprises determining, via the processor, whether the vehicle is moving based on sensor data obtained from one or more accelerometers for the vehicle.

8. The method of claim 1, wherein the step of determining whether the vehicle is moving comprises determining, via the processor, whether the vehicle is moving based on a signal obtained from an external global navigation satellite system (GNSS) device.

9. A system for a vehicle, the system comprising:
a processor configured to at least facilitate:
receiving a first indication of a possible event having occurred for a vehicle;
upon receiving the first indication, determining whether the vehicle is moving; and
providing instructions for transmitting an emergency call from the vehicle to a remote server, when both of the following conditions are satisfied, namely:
the first indication has been received; and
the vehicle is not moving; and
a transceiver coupled to the processor and configured for transmitting the emergency call in accordance with the instructions from the processor.

10. The system of claim 9, wherein the first indication comprises an indication of a loss of communications with a system of the vehicle.

11. The system of claim 10, wherein the first indication comprises an indication of a loss of communications with an event detection system of the vehicle.

12. The system of claim 11, wherein the first indication further comprises an additional indication of a loss of communications with a global navigation satellite systems (GNSS) for the vehicle.

13. The system of claim 9, wherein the processor is configured to at least facilitate determining whether the vehicle is moving based on sensor data obtained from one or more wheel sensors for the vehicle.

14. The system of claim 9, wherein the processor is configured to at least facilitate determining whether the vehicle is moving based on sensor data obtained from one or more speedometers or accelerometers for the vehicle.

15. The system of claim 9, wherein the processor is configured to at least facilitate determining whether the vehicle is moving based on a signal obtained from an external global navigation satellite system (GNSS) device.

16. A vehicle comprising:
an event detection system;
one or more sensors configured to generate sensor data;
a processor configured to at least facilitate:
receiving a first indication of a possible event having occurred for a vehicle, based at least in part on a loss of communications with the event detection system;
upon receiving the first indication, determining whether the vehicle is moving, based at least in part on the sensor data; and
providing instructions for transmitting an emergency call from the vehicle to a remote server, when both of the following conditions are satisfied, namely:
the first indication has been received; and
the vehicle is not moving; and
a transceiver coupled to the processor and configured for transmitting the emergency call in accordance with the instructions from the processor.

17. The system of claim 16, wherein the first indication further comprises an additional indication of a loss of communications with a global navigation satellite systems (GNSS) for the vehicle.

18. The vehicle of claim 16, wherein:
the vehicle sensors comprise one or more wheel sensors configured to generate wheel sensor data; and
the processor is configured to at least facilitate determining whether the vehicle is moving based on the wheel sensor data.

19. The vehicle of claim 16, wherein:
the vehicle sensors comprise one or more receivers configured to receive a signal from an external global navigation satellite system (GNSS) device; and
the processor is configured to at least facilitate determining whether the vehicle is moving based on the signal.

20. The vehicle of claim 16, wherein:
the vehicle sensors comprise one or more accelerometers configured to generate accelerometer data for the vehicle; and
the processor is configured to at least facilitate determining whether the vehicle is moving based on the accelerometer data.
